(19) United States
(12) Patent Application Publication
(10) Pub. No.: US 2026/0181733 A1
(43) Pub. Date: Jun. 25, 2026

(54) ASSIGNMENT OF NODE IDENTIFIERS IN A 10BASE-T1S NETWORK

(71) Applicant: Microchip Technology Incorporated, Chandler, AZ (US)

(72) Inventors: Willaim T. Baggett, Austin, TX (US); Thorsten Kummermehr, Ubstadt-Weiher (DE); Martin Miller, Karlsruhe (DE)

(21) Appl. No.: 19/537,266

(22) Filed: Feb. 11, 2026

Related U.S. Application Data
(63) Continuation-in-part of application No. PCT/US2024/050814, filed on Oct. 10, 2024.
(60) Provisional application No. 63/519,157, filed on Aug. 11, 2023.

(51) Int. Cl. H04W 84/18; H04L 41/22; H04L 45/28

(52) U.S. Cl. CPC H04W 84/18; H04L 41/22; H04L 45/28

(57) ABSTRACT

An apparatus may include a physical layer (PHY), a reconciliation sublayer (RS), a Media Access Control layer (MAC), and a logic circuit acting as a Central Segment Controller or Local Node Manager. The PHY may interface with a shared transmission medium of a network. The RS may support Physical Layer Collision Avoidance (PLCA), and the circuit may send a request to register a node with a network, and derive a node identifier for use by the PLCA RS to determine transmit opportunities, wherein the node identifier is at least partially derived from the node's position in a table of registered nodes in the network received in response to the registration request.

### CROSS-REFERENCE TO RELATED APPLICATION

Pursuant to 35 U.S.C. § 111 (a), this application is a continuation-in-part of International Patent Application PCT/US2024/050814 filed Oct. 10, 2024, designating the United States and entitled Assigning Node Identifiers in a 10BASE-TIS Network, which claims the benefit of U.S. Provisional Application No. 63/519,157, filed Aug. 11, 2023, the contents and disclosure of which is incorporated herein in its entirety by this reference.

### BACKGROUND

10 Megabits (Mb/s) Single Twisted Pair Ethernet (also referred to as “10BASE-T1S”) is a network technology, and it may be used in vehicle, industrial, and other networking systems. 10BASE-T1S may be used to provide a collision free, deterministic transmission on a network.

For example, in 10BASE-T1S, a single twisted pair cable may simultaneously transmit and receive data from multiple devices or nodes. 10BASE-TIS may use a Carrier Sense Multiple Access with Collision Detection (CSMA/CD) protocol as specified in IEEE 802.3 Clause 4, to detect collisions. In the CSMA/CD protocol, since multiple nodes may access the bus simultaneously, collisions may occur if more than one node accesses at the same time. In response to a collision detection, a node may perform a collision resolution routine such as a back-off algorithm. For example, in response to a collision detection, a node may halt access and wait for a pre-specified or random period of time as determined by each individual node before attempting to access the bus again.

As a further example, the IEEE 802.3cg clause 148 protocol, also known as Physical Layer Collision Avoidance (PLCA), may improve the CSMA/CD protocol by avoiding collisions. PLCA provides each node with a specific transmit opportunity. The transmit opportunities may avoid physical collisions on the transmission line by providing each node with a different, distinct opportunity to transmit on the bus. To ensure unique assignment of transmit opportunities, each node is assigned a distinct identifier (PLCA ID) and each PLCA ID is assigned to a unique transmit opportunity. In dynamic network environments, nodes may be added or removed, requiring assignment of PLCA IDs and corresponding unique transmit opportunities to ensure efficient communication.

### BRIEF DESCRIPTION OF THE DRAWINGS

To easily identify the discussion of any particular element or act, the most significant digit or digits in a reference number refer to the figure number in which that element is first introduced.

FIG. 1 is a diagram representing an automotive system incorporating aspects of the subject matter described herein in accordance with one or more examples;

FIG. 2 is a diagram illustrating a system having a node device structure of a 10BASE-T1S network in accordance with one or more examples;

FIG. 3 is a diagram of a data structure used to implement aspects of the subject matter described in accordance with one or more examples;

FIG. 4 is a flow diagram of an initialization process in accordance with one or more examples;

FIG. 5 is a flow diagram illustrating a process of a Central Segment Controller function on a PLCA coordinator node, in accordance with one or more examples;

FIG. 6 is a flow diagram illustrating a process or algorithm pseudocode of a state machine used by a follower node in accordance with one or more examples;

FIGS. 7 to 11 are diagram captures that illustrate the network traffic in accordance with one or more examples;

FIG. 12 is a graph of the simulation output data from the PLCA cycles of FIG. 6 in accordance with one or more examples; and

FIG. 13 is a block diagram of a software system in accordance with one or more examples.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flow diagram, a flow diagram, a structure diagram, or a block diagram. Although a flow diagram may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

A 10BASE-T1S network enabled to run PLCA protocol may require the addition, removal, or replacement of nodes during the life of the network. Some of the nodes in the network may be structurally equivalent, for example, without limitation, the nodes may be the same component. Each node may be logically configured through microcontroller programs or firmware to enable a unique node ID to be automatically assigned to any node introduced to or preexisting in the network when a change in the network may be made. Each node with an assigned PLCA ID may have the opportunity to transmit at a time determined by an order of the nodes in the network and/or its assigned PLCA ID.

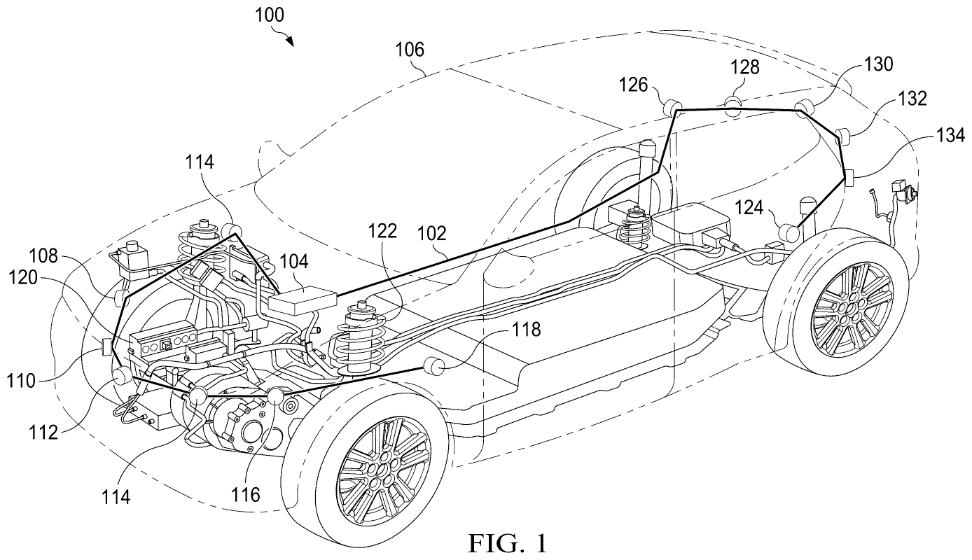

FIG. 1 is a diagram representing an automotive system incorporating aspects of the subject matter described herein in accordance with one or more examples. In FIG. 1, a 10BASE-T1S automotive network 100 may be configured to include a multi-drop shared medium 102 for connecting an electronic control unit (ECU) 104 of a vehicle body 106 to a number of nodes or devices. As used herein, the term “node” is intended to be used interchangeably with “device.” A node or device may be hardware, software, or various combinations of hardware and software. It should be recognized that although only one shared medium 102 with only one ECU 104 is highlighted, one or more examples of automotive networks may feature multiple networks in multiple zones within one vehicle. In an illustrative non-limiting example, nodes 124, 126, 128, 130, 132 and 134 may be considered a first zone of the network. In another illustrative non-limiting example, nodes 110, 112, 114, 116, and 118 may be designated as another separate second zone of the network.

The nodes may include, for example, without limitation, sensors 108, 110, 112, microphones 114, switches 116, 118, or actuators 120, 122. Each node, or component, may be programmed according to a PLCA protocol, and optionally according to a CSMA/CD protocol, to control one or more functions of a system. In the multi-drop shared medium 102, each node may be capable of transmitting and receiving at the same time. In one or more examples, each node may be configured with a data structure (not shown) that upon a reset or initialization, provides each node with the capability of operating in PLCA mode as a coordinator or a follower. Any PLCA node may be randomly selected as a coordinator. There may only be one PLCA node selected as a coordinator per network bus segment. Any PLCA node that is not a coordinator is by default determined to be a follower. PLCA coordinators are assigned an identification (ID) of zero. In one or more examples of this disclosure, all followers are initialized with an ID of one regardless of the number of nodes that may be part of the network.

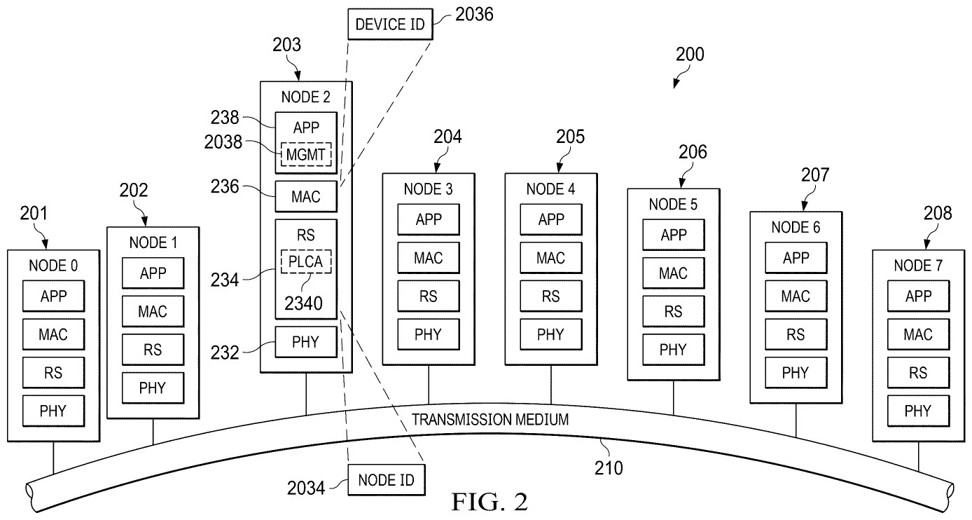

FIG. 2 is a diagram illustrating a system 200 having a node device structure of a 10BASE-T1S automotive network in accordance with one or more examples. In the specific non-limiting example depicted by FIG. 2, system 200 may include a number of nodes including node 0 201, node 1 202, node 2 203, node 3 204, node 4 205, node 5 206, node 6 207, and node 7 208. It should be understood that the number of nodes is not limited to the illustrated nodes and may comprise any number of nodes. System 200 includes a transmission medium 210, which connects to the multiple nodes of system 200. The multiple nodes of system 200 may be configured to share the transmission medium 210. In this disclosure, the term “share” may be construed to mean access to or use of a common entity or element.

The nodes may be organized into layers according to the Open Systems Interconnection (OSI) model that provides a standard for communications over a network. The OSI model includes at least seven distinct layers including a physical layer, a data link layer, a network layer and an application layer. The layers of the OSI model may be further divided into sublayers to handle specific tasks, accesses or identifiers associated with the OSI model layer. In the illustrative example of FIG. 2, the nodes are shown with the layers and sublayers that may govern or control data transmission. For ease of representation, a number of details of the node layers and node sublayers are illustrated only with respect to node 2 203. However, it should be understood that all the nodes that share access to transmission medium 210 include the same details as those illustrated in node 2 203.

In the illustrated embodiment of FIG. 2, all the nodes, as represented by node 2 203, include a physical layer PHY 232 and an application layer APP 238. The PHY 232 may interface with the transmission medium during transmission opportunities. The APP 238 may interface with the network and other user applications, such as, without limitation, microcontroller programs or firmware. The reconciliation sublayer RS 234 is a sublayer of the PHY 232 and may support the PLCA 2340 protocol. The RS 234 interacts with a media access sublayer MAC 236 of a data link layer (not shown) for transmission opportunities. The MAC 236 sublayer may include a unique address device ID 2036 to identify the particular node or device in the system or network. The MAC 236 may support the CSMA/CD protocol, which is always enabled. The device ID 2036 may be a 12-bit alphanumeric number assigned by a manufacturer to represent the physical address of the device. Sublayer RS 234 of PHY 232 may be assigned a unique node ID 234 to identify the node on the network.

The unique node ID 2034 may be, for example, without limitation, a 128-bit number. Node ID 2034 may be determined by the position or node 2 203 in the network (for example, as may be indicated by position in a broadcast table, without limitation). Node 2 203 may maintain a broadcast table that identifies all the other nodes connected to the network of system, for example, node 0 201, node 1 202, node 3 204, node 4 205, node 5 206, node 6 207, and node 7 208.

APP 238 may include firmware or software management MGMT 2038 that control at least some of the operations of node 203. In one or more illustrative examples, MGMT 2038 may be a local node controller, herein referred to as a Central Segment Controller, that may govern at least some operations of node 2 203 based on a data structure that may define the various operations of a node, including, without limitation, the transmission opportunities on transmission medium 210. In one or more illustrative examples, MGMT 2038 may be implemented as a logic circuit at least partially based on the data structure that declares the definition of variables used by the MGMT 2038 to govern various tasks, as a non-limiting example, of the MAC 236, PHY 232, or RS 234 associated with determining and managing a node ID, managing a broadcast table, or managing transmit opportunities—as more generally described below. Such data structure may be stored in a respective memory (not shown) of each of the nodes.

Node 2 203 may support the CSMA/CD protocol through the MAC 236 and the PLCA 2340 protocol through the RS 234, and may be configured to enable or disable the functionality associated with CSMA/CD protocol or the functionality associated with the PLCA RS protocol as may be determined by the network or MGMT 2038.

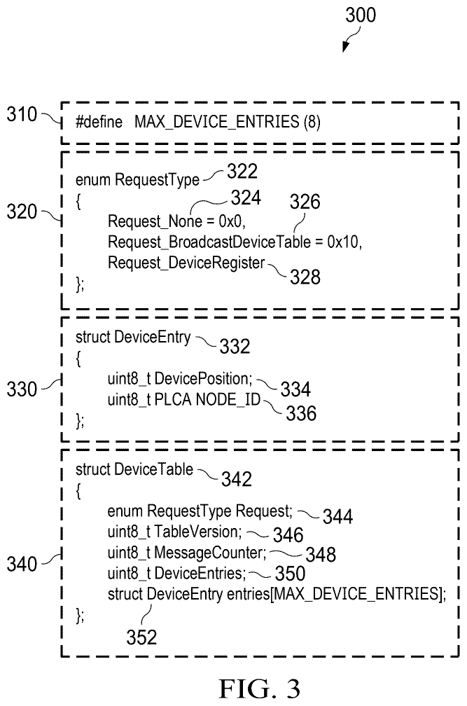

FIG. 3 is a diagram of a data structure 300 used to implement aspects of the network described in accordance with one or more examples. In the illustrative example of FIG. 3, a network may support user datagram protocol (UDP) communication traffic to send and receive packet data. UDP data structure 300 may be part of an algorithm implemented by PLCA nodes to configure each node so it may be included in the network (e.g., the network of system 200, without limitation). In one or more examples, messages based on data structure 300 may be serialized and sent as a UDP message by each node of the network. Data structure 300 defines variables and structures used by the MGMT 2038 of the node to control the operation of the node. The data structure 300 may be written in a high-level software language, such as without limitation, C++, as would be recognized by one of ordinary skill in the art.

At declaration 310, the data structure 300 defines a maximum number of devices or nodes that may be included in the network through use of a declaration “#define.” In the non-limiting example of data structure 300, #define declaration is used to declare a global constant MAX_DEVICE_ENTRIES to have a constant value. In this non-limiting example, MAX_DEVICE_ENTRIES is defined to be a constant value of 8, which means that in this specific non-limiting example the maximum number of nodes, devices, or device entries may not exceed the count of 8. In one or more examples, the network may designate one node as a coordinator node and the other nodes up to a value of MAX_DEVICE_ENTRIES as follower nodes.

At declaration 320, data structure 300 declares an enumeration (“enum”) RequestType 322. The declared enumeration assigns hexadecimal values to different types of request. In this specific example, RequestType 322 may include hexadecimal values assigned to Request_BroadcastDeviceTable 326, Request_DeviceRegister 328, and Request_None 324. Request_BroadcastDeviceTable 326 is called with a hex value of 10. Request_None 324 is called with a hex value of 0x0. Request_DeviceRegister 328 may be called with a hex value such as 0x11, without limitation.

At declaration 330, data structure 300 declares a structure, struct DeviceEntry 332, and defines fields of the DeviceEntry 332. A field DevicePosition 334 of DeviceEntry 332 may be assigned a value that indicates device position within the network, and a field PLCA Node_ID 336 of DeviceEntry 332 may be assigned a value that indicates a node identifier that corresponds to a transmit opportunity. The device position and the PLCA node ID fields may be of type integer and hold a value up to 8 bits. Optionally, DeviceEntry 332 may include a device ID, which is an 8-bit unsigned integer that indicates a unique IEEE compatible MAC address to identify a node in the system.

At declaration 340, the data structure 300 declares a structure, struct DeviceTable 342, and defines fields and structures of DeviceTable. The DeviceTable 342 may include an enumerated variable of RequestType Request 344; several fields of 8-bit unsigned integer members designated as “uint8_t,” such as, but not limited to Table Version 346, MessageCounter 348, and DeviceEntries 350; and a nested structure of DeviceEntry 332 structures, entries 352. TableVersion 346 is an 8-bit unsigned integer that may be used to keep track of the number of updates to the device table. The variable DeviceEntries 350 is an 8-bit unsigned integer that may be used to indicate how many entries are in the device array. The variable Request 344 may be assigned a hexadecimal value of 0x0 to signal a request type of Request_None; may be assigned a hexadecimal value of 0x10 to signal a request type of Request_BroadcastDeviceTable; and may be assigned a hexadecimal value of 0x11 to signal a request of request type Request_DeviceRegister.

Each node (e.g., each of nodes 204 of FIG. 2, without limitation) may include the block 340 with the construct DeviceTable 342. If the Request value is hex 0x10, the node is a coordinator node. If the Request value is 0x11, the node is a follower node. A network may have assigned the role of coordinator to one node. All other nodes outside of the designated coordinator node will have the designation of follower. The hexadecimal values used in discussion of specific examples based on FIG. 3 are not intended to limit this disclosure in any way.

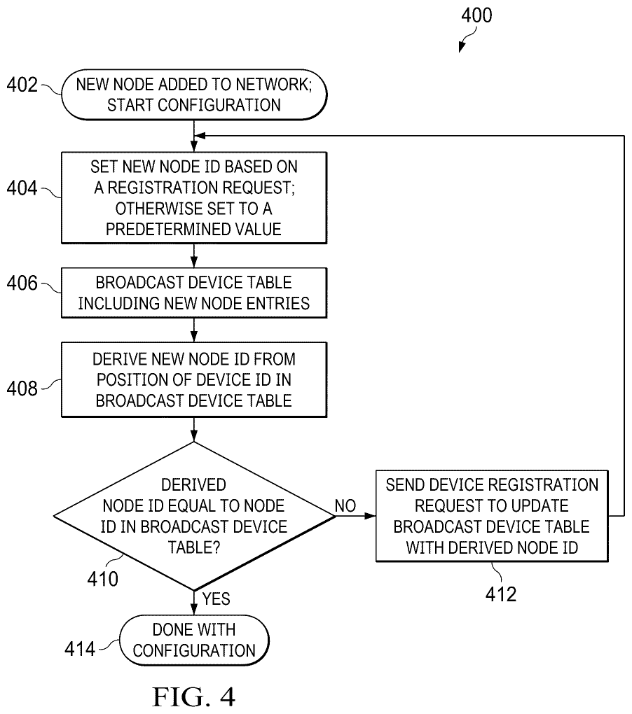

FIG. 4 is a flow diagram of an initialization process 400 in accordance with one or more examples.

Prior to the start of process 400, an initialization procedure may be executed that sets the expected node count of the PLCA network segment, a coordinator node position equal to ‘0,’ and all follower node positions equal to ‘1.’

At act 402, a new node is added to the network and may run a PLCA protocol. Initially, the new node may be identified to the coordinator node by a unique device identifier such as a MAC address, which is not the node ID or PLCA ID.

At act 404, the new node's node ID may be set based on a registration request, if a registration request with a broadcast device table including a unique node ID is provided, or set to a predetermined value that indicates the node is unconfigured. In this example, it is set to the value “node 1” to indicate the node is unconfigured. The addition of the new node may require configuration with a unique node ID based on the position of the node in the network, as discussed below.

At act 406, the table of registered nodes (also called the “BroadcastDeviceTable”) is broadcast by the Central Segment Controller coordinator node to the Local Node Manager or the follower nodes on the network. The Local Node Manager of the new follower node may receive a BroadcastDeviceTable from the coordinator node Central Segment Controller. The BroadcastDeviceTable may include one or more entries, and each entry may describe a device in the network and its respective position in the network. For example, a description may include a device identifier (e.g., a MAC address, without limitation), a node ID (e.g., a unique PLCA ID, without limitation), and information about the node's position in the network (e.g., a node's position in the network may be determined based on its position within the BroadcastDeviceTable, without limitation). It must be noted that in an initial table broadcast, the table entries may be set to 1 for unconfigured nodes.

At act 408, the Local Node Manager on the new follower node derives its unique node ID based on the position of its device ID in the broadcast device table. At act 410, the Local Node Manager node determines whether the broadcast device table matches its own device table, specifically, the PLCA node ID in its own device table. If a match, then process 400 proceeds to act 414 and the configuration is complete. If not a match, then process 400 proceeds to act 412. At act 412, the follower node sends a device register request to update the broadcast device table with the derived node ID, and process 400 proceeds to act 404, where the coordinator node receives the device register request sent in act 412 and sets the new node ID based on the derived node ID included with the device register request sent in act 412. When process 400 arrives at act 410 again, it determines that the derived node is equal to the node ID in its own device table, and proceeds to act 414 where configuration is done.

Alternatively, in one or more examples, a node may initiate the registration process by sending a registration request directly to its own Local Node Manager (e.g., MGMT 2038 of the node, without limitation) rather than directly to the Central Segment Controller on the coordinator node. In such examples, the application layer (e.g., APP 238 or other software executing on the node, without limitation) may issue an intra-node registration command to the Local Node Manager, and the Local Node Manager may process the registration command, prepare appropriate registration information (e.g., device identifier, current node ID, or other DeviceInfo, without limitation), and transmit the registration request to the Central Segment Controller on the coordinator node on behalf of the requesting node via the shared transmission medium. The Central Segment Controller may then process the registration request and update the BroadcastDeviceTable as described herein. In such examples, the Local Node Manager may act as an intermediary that manages the registration process on the node, abstracting the details of communication with the Central Segment Controller from the application layer or other higher-level functions of the node.

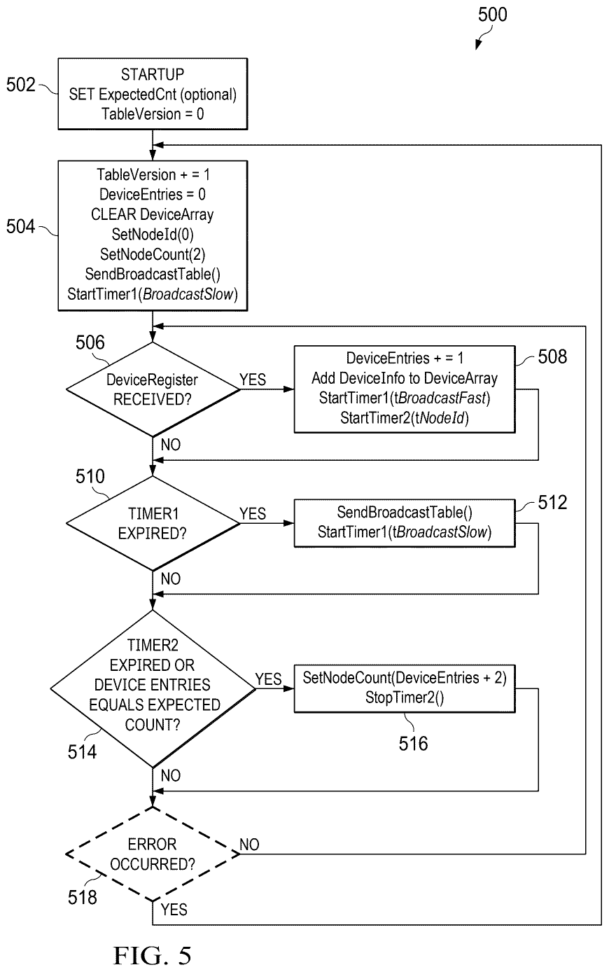

FIG. 5 is a flow diagram illustrating a process of a Central Segment Controller function on a PLCA coordinator node, in accordance with one or more examples. The process may be implemented by an algorithm 500. At act 502, algorithm 500 may include a reset or startup phase. During the reset or startup phase, the algorithm may first designate a node or device to be the Central Segment Controller coordinator node of the network. In one or more examples, any of the nodes in the network may be capable of being set as the coordinator node. However, it is important to note that, at a given time, only a single node may be set as the coordinator node in the network. Additionally, it must be noted that the coordinator node designation is not exclusive to any one particular node over multiple cycles. After each reset cycle, any device or node may be set to perform the Central Segment Controller coordinator node function.

In one or more examples, the reset or startup phase of act 502 may occur after (e.g., may be triggered by, without limitation) a system reset. At act 502, a variable, Table Version, of the Central Segment Controller coordinator node may reset to a zero value. Optionally, at act 502, a variable, ExpectedCnt, which provides a count of the number of devices or nodes in the network, may also be set. The algorithm may then proceed to act 504 to configure other variables.

At act 504, algorithm 500 may cause initialization of the table and follower nodes through the Local Node Manager. At act 504, TableVersion, which tracks the number of cycles in the network, may be incremented by 1. At act 504, the Device Array is cleared. The device array may hold information of all the device entries in the network. At act 504, SetNodeId(0) sets a node ID, of the node that will function as the Central Segment Controller coordinator node, to 0. At act 504, the node count of the network is set to a value of “2,” SetNodeCount(2). The setting to “2” means that the network only recognizes a total of two transmit opportunities in the network. Node 0 is the Central Segment Controller coordinator Node. All other nodes will be designated as follower nodes and will be set to a default value of 1. At act 504, the Central Segment Controller of the coordinator node may issue an initial SendBroadcastTable( ), which sends a table array of all the nodes in the network. The node ID of the coordinator will be set to zero. The node ID of the follower nodes may all be set to 1 in the initial table. At act 504, the Central Segment Controller of the coordinator node may start a timer, StartTimer1, which results in iterative slow broadcasts of the table, which the algorithm will recognize as the DeviceEntries variable, which specifies the number of devices in a device array is incremented by one.

At act 506, the Central Segment Controller of the coordinator node determines whether it received DeviceRegister information from a Local Manager on a remote node on the segment. The Device Register is a request from a node of the network to be registered in the Device Array and be assigned a Node ID.

If the coordinator node determines that a Device Request was received, then at act 508, algorithm 500 may register a node with the network. At act 508, algorithm 500 may increment the variable DeviceEntries (e.g., increased by one, without limitation) to indicate the number of devices in the network including the new device. At act 508, algorithm 500 may add the node or device information, DeviceInfo, to the device table array, DeviceArray. At act 508, algorithm 500 may start StartTimer1 and control a continual broadcast from the Central Segment Controller of the coordinator node. For example, without limitation, the timer may be set to broadcast table array information every 2 milliseconds. At act 508, StartTimer2 controls the start of a second timer of a Local Node Manager node. For example, a Local Node Manager node may start Timer 2 as the Local Node Manager node updates information in the device table array. Timer 2 may be set to, for example, without limitation, 50 milliseconds (50 ms).

At act 510, algorithm 500 determines whether or not Timer1 was expired. If the response to the query (whether or not Timer1 expired) is “yes” or positive, then at act 512, algorithm 500 broadcasts an updated table array, SendBroadcastTable( ), starts Timer1, StartTimer1, which is the slow timer (as compared to Timer2), and proceeds to act 514. At act 510, if the response to the query (the query of whether Timer1 expired) is “No” or negative, the algorithm 500 proceeds to act 514, and determines whether or not Timer2 is expired, or whether or not the number of device entries, DeviceEntries, equals the expected count, ExpectedCnt.

At act 514, the algorithm 500 determines whether or not a Local Node Manager of a follower node has completed its update of the device table array based on the timer, Timer2. Alternatively, algorithm 500 may determine whether or not all the Local Node Managers of the follower nodes have been serviced by checking the value of the expected count, ExpectedCnt. If the response to act 514 is negative or “No,” the algorithm 500 may, at optional act 518, determine whether or not an error occurred. If the response to the query of act 518 is negative or “No” error occurred, then the flow diagram loops back to act 506 and the algorithm 500 returns to determining whether or not another device register request is received (506).

If the response to the query at act 514 is affirmative or “yes,” then at act 516, the algorithm may set the number of node entries to the number of exiting nodes registered in the table plus two, SetNodeCount (DeviceEntries+2), to account for the coordinator node, which has a node ID of 0, and the broadcast channel, which has a node ID of 1. At act 516, algorithm 500 stops Timer2, StopTimer2( ). At act 518, the algorithm 500 determines whether or not an error occurred. If there is an error, the algorithm restarts from the beginning at act 504. If there is no error, then the process restarts and transitions back to act 506.

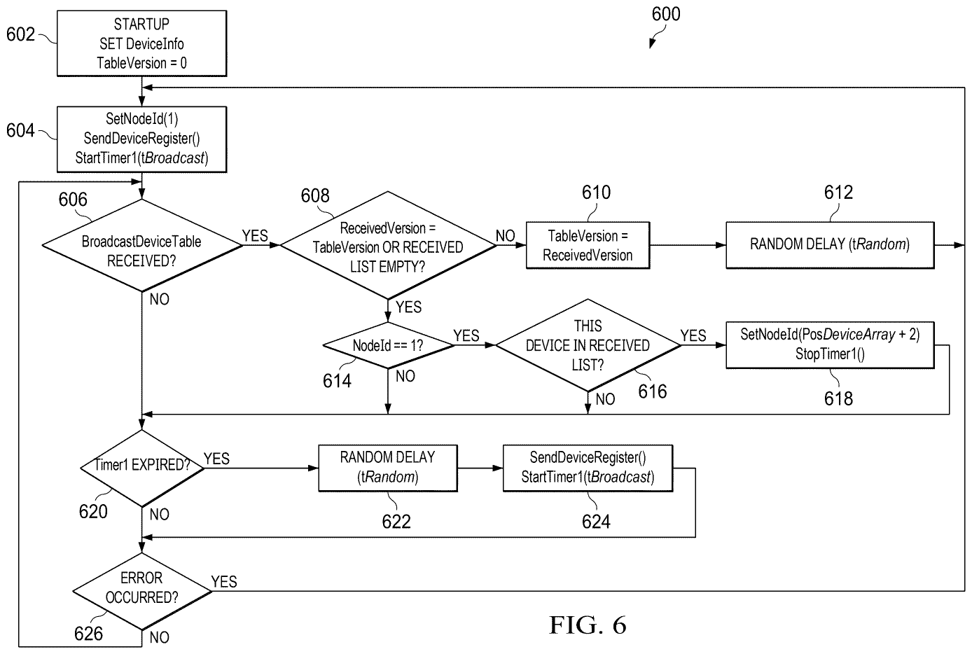

FIG. 6 is a flow diagram illustrating a process or algorithm 600, pseudocode of a state machine used by the Local Node Manager of a follower node in accordance with one or more examples. At act 602, algorithm 600 may set unique device information, SetDeviceInfo, of a follower node. For example, algorithm 600 may set a unique MAC address and node ID to its current number in the network. Optionally, the algorithm 600 may initialize its table version to 0, Table Version=0.

At act 604, algorithm 600 may set node IDs of all respective follower nodes, SetNodeId(1), to a value of ‘1.’ It must be noted that the setting of a follower node ID and the setting of a maximum node ID on the network will trigger the PLCA protocol. At act 604, algorithm 600, which is registered with a Node ID of 1, accesses (e.g., gains control of, without limitation) the shared medium and sends a request to register itself in the broadcast table, SendDeviceRegister. At act 604, algorithm 600 starts a timer, StartTimer1, after it sends the request to register the node to the Central Segment Controller on the coordinator node.

At act 606, algorithm 600 determines whether the Central Segment Controller coordinator node has sent a table array (e.g., whether or not the follower node received a table array from the coordinator node, without limitation), BroadcastDeviceTable Received. If the response to the query is affirmative or “yes,” at act 608, algorithm 600 compares the Table Version received from the Central Segment Controller on the coordinator node to the Table Version at the node, ReceivedVersion equals TableVersion. If the query of Table Version received from the Coordinator is empty, is negative, or No, or the query of Received List empty is No, then at act 610, the algorithm 600 sets the count of the Table Version equal to the count of the Received Version. At act 612, algorithm 600 waits for a random delay determined by a respective random number generator seeded by a number before it sends a new device request at act 604.

Returning to act 608, if the response to the query is affirmative or “yes,” then at act 614, the algorithm 600 determines whether or not the follower node has the ID of 1, NodeID=1, which allows it to transmit data. If the query response is affirmative or “yes” then at act 616, the algorithm 600 determines whether or not the node ID is in the broadcast array, Device in Received List. If the response is affirmative or “yes,” then at act 618, the algorithm 600 sets its node ID to its position in the Device Array+2, SetNodeID (PosDeviceArray+2), to account for the presence of the coordinator node and the follower node. At act 618, algorithm 600 stops Timer1, the broadcast timer, since the update is complete, and algorithm 600 loops back to act 620 to query whether Timer1 is active or not active (e.g., whether or not Timer1 is active, without limitation).

If the response to the query at act 620 is affirmative or “yes,” then at act 622, algorithm 600 adds a buffer of time to a delay, Random delay, before algorithm 600 attempts to resend a request to register itself in the broadcast table, SendDeviceRegister, to the Central Segment Controller on the coordinator node, update array. At act 624, the follower node may send its information to the array table in the coordinator node, SendDeviceRegister. At act 624, algorithm 600 restarts Timer1. At act 626, algorithm 600 determines whether or not an error occurred. If algorithm 600 determines an error occurred, then the flow diagram returns to act 604. If algorithm 600 determines no error occurred, the flow diagram returns to act 606 to determine whether or not a new cycle has started by receipt of the Broadcast Table.

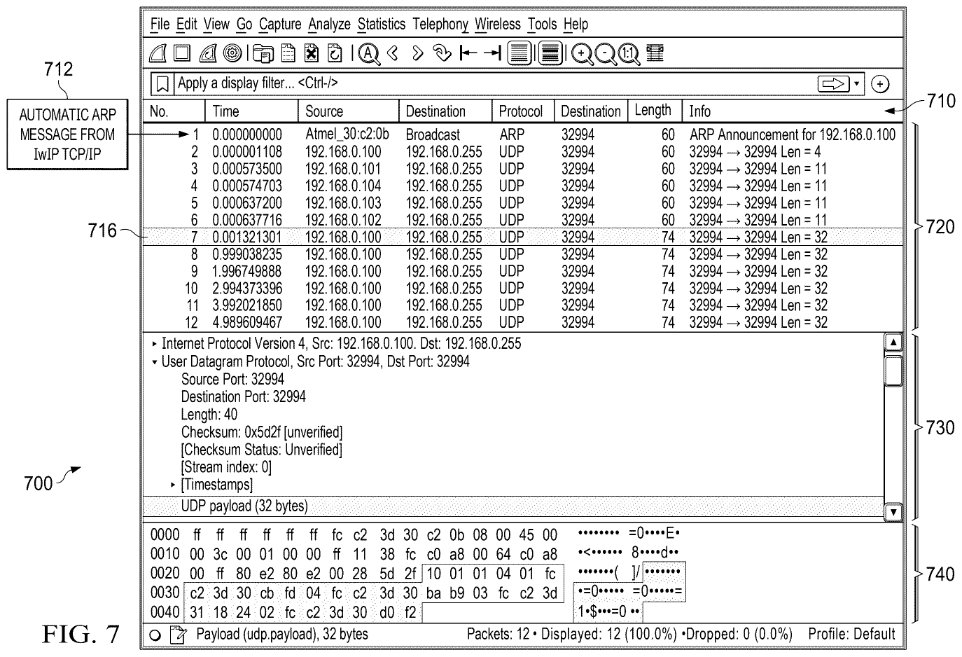

FIGS. 7 through 11 are captures by a network protocol analyzer showing example traffic over a network, in accordance with one or more examples.

Turning first to FIG. 7, a display screen 700 of an analyzer shows a header panel 710 that includes a packet summary that shows packet details including columns for time, which is when the packet was captured; a column for source, which is the IP address of the device that sent the packet; a column for destination, which is the target IP address or broadcast address; a column for the protocol, which is the protocol used (e.g., ARP, UDP); a column for length, which is the size of the packet in bytes. In this example, the top panel 720 indicates Packet 1 712 is an ARP announcement and Packets 2 through 12 are UDP packets. Packet 7 716 is highlighted as the destination packet.

The middle panel 730 includes packet details, including protocol details, Internet Protocol Version (IPv4), the source port (32994), the destination port (32994-indicating the same service on both sides), and a checksum (unverified but this is typical in UDP traffic).

The bottom panel 740 includes hexadecimal data and its ASCII translation for the selected packet. Here, the selected packet is payload sent over UDP.

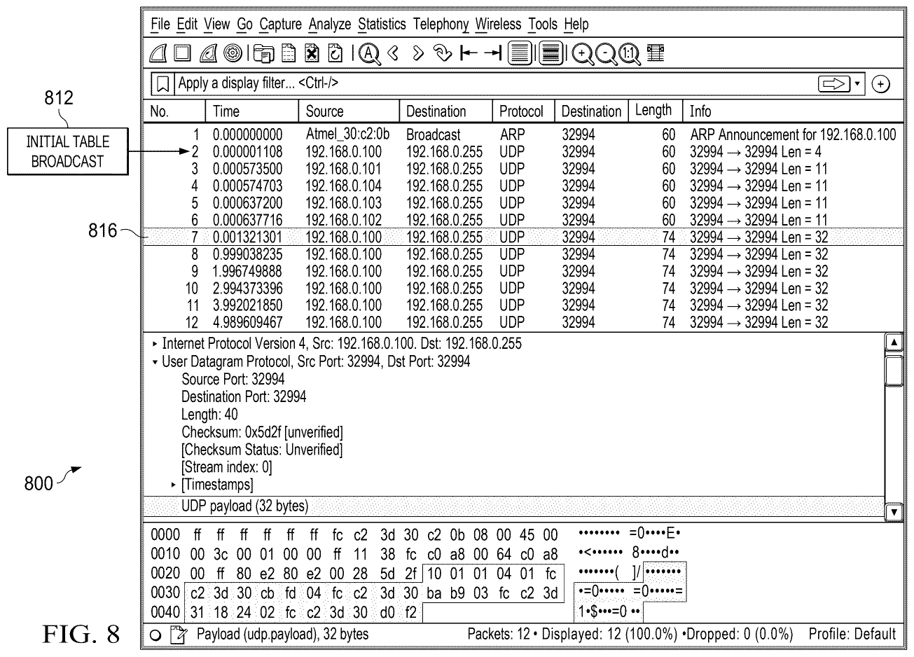

Turning to FIG. 8, screen display 800 is the same capture but includes an annotation that highlights “initial table broadcast,” 812 next to ARP announcement and the UDP packets. The annotation points to a specific time in the capture (around 0.000000000 seconds) corresponding to the first ARP packet, followed by the series of UDP packets. This annotation indicates the first broadcast of a table. The ARP announcement signals the start of communication for node discovery or network initialization. The following UDP packets represent the initial broadcast of the table of registered nodes or network management messages, as indicated by the repetitive nature and similar length of the packets (32 bytes). Packet 7 816 is again highlighted as the destination packet.

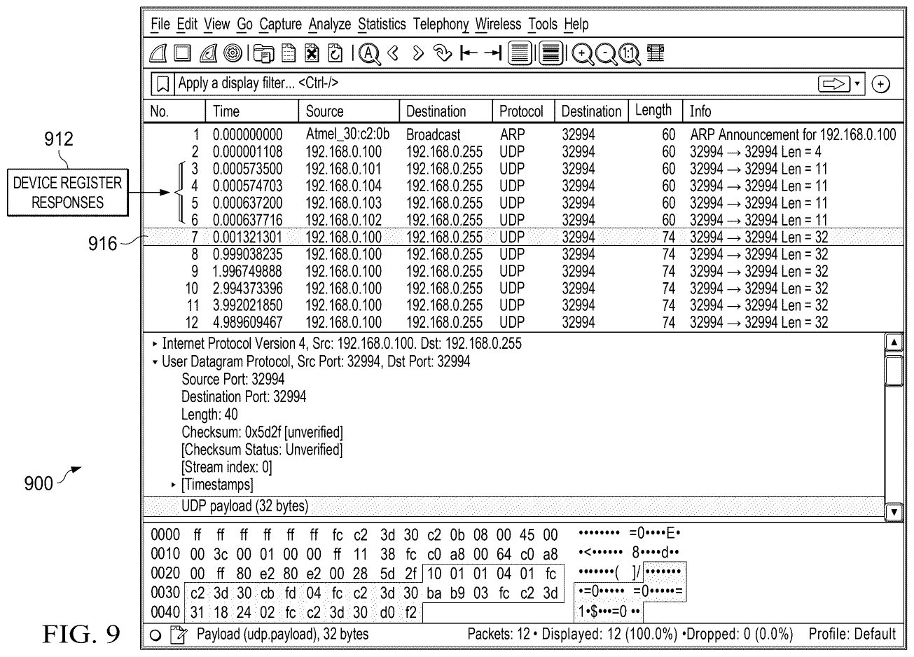

Turning to FIG. 9, screen display 900 is the same capture but includes an annotation that highlights “device register responses” 912. This annotation emphasizes that these UDP packets are related to the registration process where devices are either requesting to be added to the network or responding to the coordinator's table broadcast, updating the coordinator on their status. This annotation marks the series of UDP packets (packets 6, 7, and onward) as responses to the device registration process. In a PLCA network (or any managed network), new nodes need to register with a coordinator to receive a node identifier (PLCA ID) and to be included in the broadcast table. These UDP packets represent the messages sent by newly connected follower nodes to the coordinator or by the coordinator itself, acknowledging the registration of those nodes. Following the initial broadcast (highlighted in previous captures), these packets would be part of the process where nodes are responding to the initial table broadcast or sending their registration requests. The payload in these UDP packets contain information about the node's registration status, node identifier (PLCA ID), or other relevant data needed for the coordinator to update the broadcast table. Packet 7 916 is again highlighted as the destination packet.

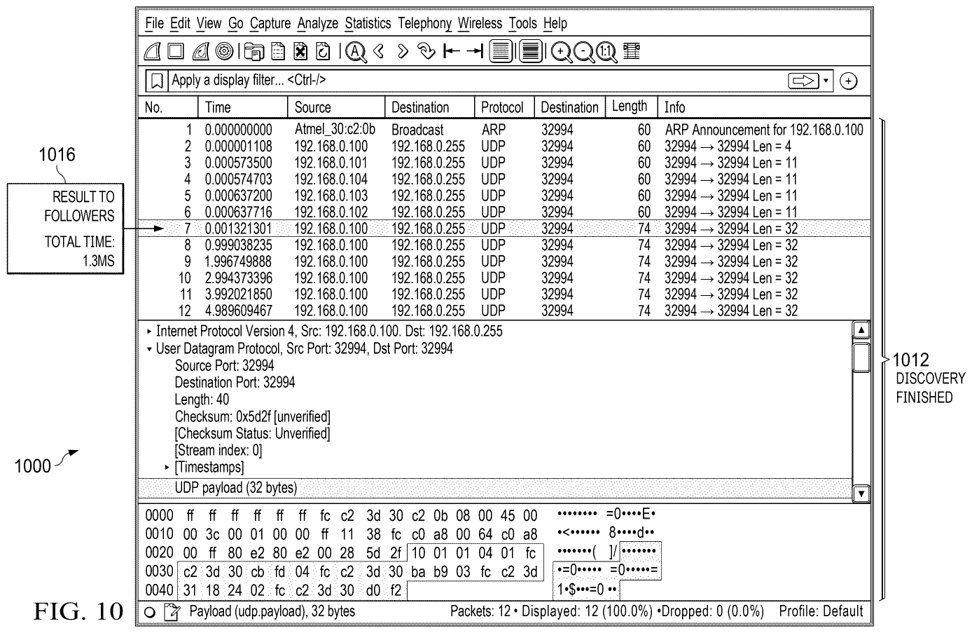

Turning to FIG. 10, screen display 1000 is the same capture but includes annotations that highlight phases of the communication process, including “discovery finished,” “Result to followers, total time 1.3 ms” 1016. The annotation “Discovery finished” 1012 refers to the end of the node discovery phase, where all nodes in the network have been identified and registered. This phase involves gathering and broadcasting the initial table of registered nodes, as indicated in earlier captures depicted by FIGS. 7 through 9.

The annotation “Results to Followers” in 1016 refers to after the discovery phase, when the coordinator sends the results (for example, an updated table of registered nodes) to the follower nodes. This broadcast informs the followers about their assigned node identifiers (PLCA IDs) and other relevant network information, enabling them to participate in the network and handle their transmit opportunities properly.

The annotation “Total Time: 1.3 ms” in 1016 indicates the total time taken for the discovery and broadcasting process (including sending the results to the followers). The time is relatively short (1.3 milliseconds), demonstrating the efficiency of the process.

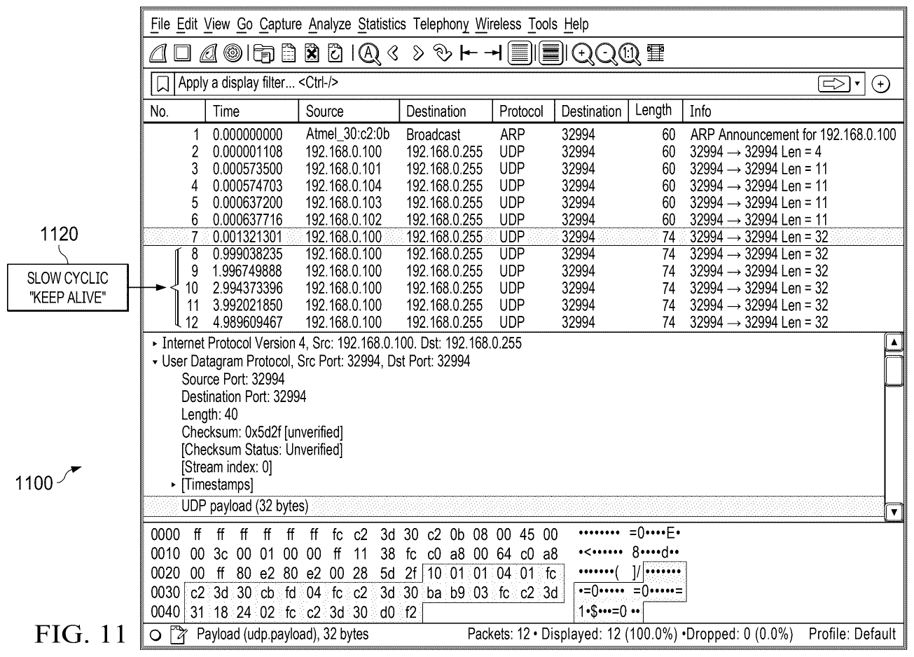

In FIG. 11, screen display 1100 illustrates the same capture as FIGS. 7-10 but includes an annotation “slow cyclic ‘keep alive’” 1120 that highlights a recurring process where nodes in the network periodically send or receive messages to signal that they are still active and maintaining their connection with the network.

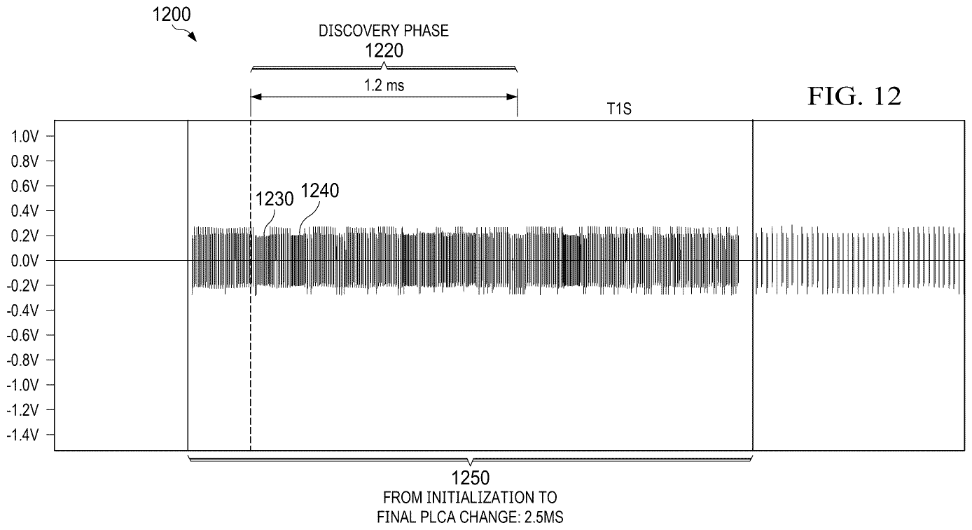

FIG. 12 is a graph 1200 based on a digital trace or oscilloscope capture (e.g., from a logic analyzer tool such as Saleae Logic Pro), which may be used to analyze electrical signals over time. The graph shows signal changes across time in milliseconds (ms) on the horizontal axis, and the voltage (V) levels on the vertical axis.

The waveform indicates voltage transitions over time, which might correspond to network communication signals, such as the exchange of messages during the discovery and initialization phase in a PLCA or CSMA network.

The discovery phase 1220 of the network—where nodes are detected and registered—was completed in 1.2 milliseconds. During this phase, signals represent the communication between nodes or a broadcast of the network's discovery results.

The time taken from the start of the initialization phase to the final PLCA (Physical Layer Collision Avoidance) 1250 adjustment was 2.5 milliseconds. Initialization could include processes like node registration, table broadcasts, and collision avoidance setup.

The signal transitions, such as 1230 and 1240, represent data exchange or synchronization pulses between nodes during network discovery and PLCA configuration.

The flat regions represent idle times or periods when no significant data was being transmitted.

The second phase of signals after the discovery phase 1220 represents activity related to PLCA after the nodes have been configured.

It will be appreciated by those of ordinary skill in the art that functional elements of examples disclosed herein (e.g., functions, operations, acts, processes, or methods) may be implemented in any suitable hardware, software, firmware, or combinations thereof. FIG. 4 illustrates non-limiting examples of implementations of functional elements disclosed herein. In some examples, some or all portions of the functional elements disclosed herein may be performed by hardware capable of carrying out the functional elements.

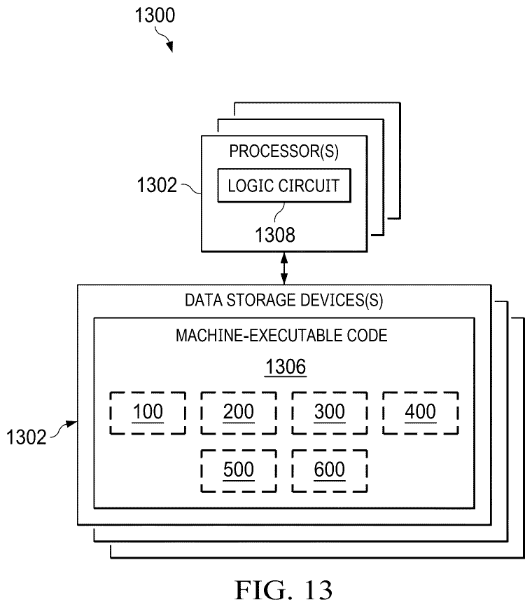

FIG. 13 is a block diagram of a circuitry 1300 that, in some examples, may be used to implement various functions, operations, acts, processes, or methods disclosed herein. The circuitry 1300 includes one or more processors 1302 (sometimes referred to herein as “processors 1302”) operably coupled to one or more data storage devices 1304 (sometimes referred to herein as “storage 1304”). The storage 1304 includes machine-executable code 1306 stored thereon, and the processors 1302 include logic circuit 1308. The machine-executable code 1306 information describing functional elements may be implemented by (e.g., performed by) the logic circuit 1308. The logic circuit 1308 is adapted to implement (e.g., perform) the functional elements described by the machine-executable code 1306. The circuitry 1300, when executing the functional elements described by the machine-executable code 1306, should be considered as special purpose hardware for carrying out functional elements disclosed herein. In some examples, the processors 1302 may perform the functional elements described by the machine-executable code 1306 sequentially, concurrently (e.g., on one or more different hardware platforms), or in one or more parallel process streams.

When implemented by logic circuit 1308 of the processors 1302, the machine-executable code 1306 adapts the processors 1302 to perform operations of examples disclosed herein, including 100, 200, 300, 400, 500 and 600. By way of non-limiting example, the machine-executable code 1306 may adapt the processors 1302 to perform some or a totality of operations for assigning node identifiers in a PLCA network segment discussed herein.

The processors 1302 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer, while the general-purpose computer executes functional elements corresponding to the machine-executable code 1306 (e.g., software code, firmware code, hardware descriptions) related to examples of the present disclosure. It is noted that a general-purpose processor (may also be referred to herein as a host processor or simply a host) may be a microprocessor, but in the alternative, the processors 1302 may include any conventional processor, controller, microcontroller, or state machine. The processors 1302 may also be implemented as a combination of computing devices, such as a combination of a DSP and a microprocessor, a plurality of microprocessors, one or more microprocessors in conjunction with a DSP core, or any other such configuration.

In some examples, the storage 1304 includes volatile data storage (e.g., random-access memory (RAM)) and non-volatile data storage (e.g., Flash memory, a hard disc drive, a solid state drive, erasable programmable read-only memory (EPROM), without limitation). In some examples, the processors 1302 and the storage 1304 may be implemented into a single device (e.g., a semiconductor device product, a system on chip (SOC), without limitation). In some examples, the processors 1302 and the storage 1304 may be implemented into separate devices.

In some examples, the machine-executable code 1306 may include computer-readable instructions (e.g., software code, firmware code). By way of non-limiting example, the computer-readable instructions may be stored by the storage 1304, accessed directly by the processors 1302, and executed by the processors 1302 using at least the logic circuit 1308. Also by way of non-limiting example, the computer-readable instructions may be stored on the storage 1304, transferred to a memory device (not shown) for execution, and executed by the processors 1302 using at least the logic circuit 1308. Accordingly, in some examples, the logic circuit 1308 includes electrically configurable logic circuit 1308.

In some examples, the machine-executable code 1306 may describe hardware (e.g., circuitry) to be implemented in the logic circuit 1308 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG®, SYSTEMVERILOG™ or very large scale integration (VLSI) hardware description language (VHDL®) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1308 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine-executable code 1306 may include an HDL, an RTL, a GL description, a mask level description, other hardware description, or any combination thereof.

In examples where the machine-executable code 1306 includes a hardware description (at any level of abstraction), a system (not shown, but including the storage 1304) implements the hardware description described by the machine-executable code 1306. By way of non-limiting example, the processors 1302 may include a programmable logic device (e.g., an FPGA or a PLC), and the logic circuit 1308 may be electrically controlled to implement circuitry corresponding to the hardware description into the logic circuit 1308. Also by way of non-limiting example, the logic circuit 1308 may include hard-wired logic manufactured by a manufacturing system (not shown, but including the storage 1304) according to the hardware description of the machine-executable code 1306.

Regardless of whether the machine-executable code 1306 includes computer-readable instructions or a hardware description, the logic circuit 1308 is adapted to perform the functional elements described by the machine-executable code 1306 when implementing the functional elements of the machine-executable code 1306. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: a physical layer (PHY) to interface with a shared transmission medium of a network; a reconciliation sublayer (RS) that supports Physical Layer Collision Avoidance (PLCA); a Media Access Control layer (MAC); and a Local Node Management logic circuit to: send a request to register a node with a Central Segment Controller; and derive a node identifier for use by the PLCA RS to determine transmit opportunities, wherein the node identifier is at least partially derived from the node's position in a table of registered nodes in the network received in response to the registration request.

Example 2: The apparatus according to Example 1, comprising a memory to store a data structure, wherein the data structure to store node and network management information.

Example 3: The apparatus according to Examples 1 and 2, wherein the data structure defines: a registration request type to register nodes with the Central Segment Controller; a device entry structure to store information about nodes in the network; and a device table structure to maintain device entries, indicate operations performed in relation to the network, track status of operations performed in relation to the network, and track status of the table of registered nodes.

Example 4: The apparatus according to any of Examples 1 to 3, wherein the logic circuit to send the request to register the node with the Central Segment Controller based on the defined registration request type.

Example 5: The apparatus according to any of Examples 1 to 4, wherein the logic circuit to update an entry with the derived node identifier, the entry being based on the defined device entry structure.

Example 6: The apparatus according to any of Examples 1 to 5, wherein the logic circuit to update a device table with node and network management information, the device table being based on the defined device table structure.

Example 7: The apparatus according to any of Examples 1 to 6, wherein the logic circuit to: receive the table of registered nodes from the Central Segment Controller on the network; in response to a determination that the node does not have a unique node identifier, derive the node identifier from the node's position in the table of registered nodes; update the table of registered nodes with the derived node identifier; and broadcast the updated table of registered nodes.

Example 8: The apparatus according to any of Examples 1 to 7, wherein the PLCA RS is enabled during reception of the table of registered nodes and the PLCA RS is disabled during transmission of the updated table of registered nodes.

Example 9: The apparatus according to any of Examples 1 to 8, wherein the PLCA RS manages transmission of the table of registered nodes during a transmit opportunity of a PLCA cycle, wherein the transmit opportunity corresponds to the derived node identifier.

Example 10: The apparatus according to any of Examples 1 to 9, wherein the PLCA RS is disabled during transmission of the updated table of registered nodes; and the PLCA RS is enabled during reception of the table of registered nodes.

Example 11: The apparatus according to any of Examples 1 to 10, wherein the logic circuit to broadcast the updated table of registered nodes after waiting a delay, the delay having a randomized time duration.

Example 12: The apparatus according to any of Examples 1 to 11, wherein the logic circuit offers modes for a PLCA follower node and for a PLCA coordinator node.

Example 13: The apparatus according to any of Examples 1 to 12, wherein the logic circuit to use a same device table structure for a respective table of registered devices maintained and broadcast when operating as a Central Segment Controller and for a respective device table maintained when operating as Local Node Manager.

Example 14: A method comprising: sending a request to register a node with a Local Node Manager; and deriving a node identifier for use by a reconciliation sublayer (RS) that supports Physical Layer Collision Avoidance (PLCA) to determine transmit opportunities, wherein the node identifier is at least partially derived from the node's position in a table of registered nodes in the network, the table of registered nodes received from a Central Segment Controller in response to the registration request.

Example 15: The method according to Example 14, comprising: storing a data structure in memory, the data structure configured to store node and segment management information.

Example 16: The method according to Examples 14 and 15, wherein the data structure defines: a registration request type to register nodes with the Central Segment Controller; a device entry structure to store information about nodes on the segment; and a device table structure to maintain device entries, indicate operations performed in relation to the network, track status of operations performed in relation to the segment, and track the status of the table of registered nodes.

Example 17: The method according to any of Examples 14 to 16, comprising: sending the request to register the node with the Central Segment Controller based on the defined registration request type.

Example 18: The method according to any of Examples 14 to 17, comprising: updating an entry with the derived node identifier, the entry being based on the defined device entry structure.

Example 19: The method according to any of Examples 14 to 18, comprising: updating a device table with node and network management information, the device table being based on the defined device table structure and broadcasting the updated table of registered nodes.

Example 20: The method according to any of Examples 14 to 19, comprising: receiving the table of registered nodes from a Central Segment Controller on the segment; in response to a determination that the node does not have a unique node identifier, deriving the node identifier from the node's position in the table of registered nodes; updating the table of registered nodes with the derived node identifier; and broadcasting the updated table of registered nodes.

Example 21: The method according to any of Examples 14 to 20, wherein the PLCA RS is enabled during reception of the table of registered nodes, and the PLCA RS is disabled during transmission of the updated table of registered nodes.

Example 22: The method according to any of Examples 14 to 21, wherein the Central Segment Controller manages transmission of the table of registered nodes.

Example 23: The method according to any of Examples 14 to 22, comprising: broadcasting the updated table of registered nodes after waiting a delay, the delay having a randomized time duration.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus, comprising:
a physical layer (PHY) to interface with a shared transmission medium of a network;
a reconciliation sublayer (RS) that supports Physical Layer Collision Avoidance (PLCA);
a Media Access Control layer (MAC); and
a Local Node Management logic circuit to:
send a request to register a node with a Central Segment Controller; and
derive a node identifier for use by the PLCA RS to determine transmit opportunities, wherein the node identifier is at least partially derived from the node's position in a table of registered nodes in the network received in response to the registration request.

2. The apparatus of claim 1, comprising a memory to store a data structure, wherein the data structure to store node and network management information.

3. The apparatus of claim 2, wherein the data structure defines:
a registration request type to register nodes with the Central Segment Controller;
a device entry structure to store information about nodes in the network; and
a device table structure to maintain device entries, indicate operations performed in relation to the network, track status of operations performed in relation to the network, and track status of the table of registered nodes.

4. The apparatus of claim 3, wherein the logic circuit to send the request to register the node with the Central Segment Controller based on the defined registration request type.

5. The apparatus of claim 3, wherein the logic circuit to update an entry with the derived node identifier, the entry being based on the defined device entry structure.

6. The apparatus of claim 3, wherein the logic circuit to update a device table with node and network management information, the device table being based on the defined device table structure.

7. The apparatus of claim 3, wherein the logic circuit to:
receive the table of registered nodes from the Central Segment Controller on the network;
in response to a determination that the node does not have a unique node identifier, derive the node identifier from the node's position in the table of registered nodes;
update the table of registered nodes with the derived node identifier; and
broadcast the updated table of registered nodes.

8. The apparatus of claim 7, wherein the PLCA RS is enabled during reception of the table of registered nodes and the PLCA RS is disabled during transmission of the updated table of registered nodes.

9. The apparatus of claim 7, wherein the PLCA RS manages transmission of the table of registered nodes during a transmit opportunity of a PLCA cycle, wherein the transmit opportunity corresponds to the derived node identifier.

10. The apparatus of claim 7, wherein the PLCA RS is disabled during transmission of the updated table of registered nodes; and the PLCA RS is enabled during reception of the table of registered nodes.

11. The apparatus of claim 7, wherein the logic circuit to broadcast the updated table of registered nodes after waiting a delay, the delay having a randomized time duration.

12. The apparatus of claim 1, wherein the logic circuit offers modes for a PLCA follower node and for a PLCA coordinator node.

13. The apparatus of claim 12, wherein the logic circuit to use a same device table structure for a respective table of registered devices maintained and broadcast when operating as a Central Segment Controller and for a respective device table maintained when operating as Local Node Manager.

14. A method comprising:
sending a request to register a node with a Central Segment Controller; and
deriving a node identifier for use by a reconciliation sublayer (RS) that supports Physical Layer Collision Avoidance (PLCA) to determine transmit opportunities, wherein the node identifier is at least partially derived from the node's position in a table of registered nodes in the network, the table of registered nodes received from the Central Segment Controller in response to the registration request.

15. The method of claim 14, comprising:
storing a data structure in memory, the data structure configured to store node and segment management information.

16. The method of claim 15, wherein the data structure defines:
a registration request type to register nodes with the Central Segment Controller;
a device entry structure to store information about nodes on the segment; and
a device table structure to maintain device entries, indicate operations performed in relation to the network, track status of operations performed in relation to the segment, and track the status of the table of registered nodes.

17. The method of claim 16, comprising:
sending the request to register the node with the Central Segment Controller based on the defined registration request type.

18. The method of claim 16, comprising:
updating an entry with the derived node identifier, the entry being based on the defined device entry structure.

19. The method of claim 16, comprising:
updating a device table with node and network management information, the device table being based on the defined device table structure and broadcasting the updated table of registered nodes.

20. The method of claim 16, comprising:
receiving the table of registered nodes from a Central Segment Controller on the segment;
in response to a determination that the node does not have a unique node identifier, deriving the node identifier from the node's position in the table of registered nodes;
updating the table of registered nodes with the derived node identifier; and
broadcasting the updated table of registered nodes.

21. The method of claim 20, wherein the PLCA RS is enabled during reception of the table of registered nodes, and the PLCA RS is disabled during transmission of the updated table of registered nodes.

22. The method of claim 20, wherein the Central Segment Controller manages transmission of the table of registered nodes.

23. The method of claim 20, comprising:
broadcasting the updated table of registered nodes after waiting a delay, the delay having a randomized time duration.
